(19) United States
(12) Patent Application Publication
(10) Pub. No.: US 2023/0276812 A1
(43) Pub. Date: Sep. 7, 2023

(54) CONFECTIONARY MIX

(71) Applicant: NISSHIN FOODS INC., Chiyoda-ku (JP)

(72) Inventors: Masashi YOSHIDA, Fujimino-shi (JP); Kenichiro TAKAMATSU, Fujimino-shi (JP); Michihiro SAKAKIBARA, Fujimino-shi (JP); Mariko HIRAUCHI, Chuo-ku (JP)

(73) Assignee: NISSHIN SEIFUN WELNA INC., Chiyoda-ku (JP)

(21) Appl. No.: 18/004,325

(22) PCT Filed: Jun. 18, 2021
(86) PCT No.: PCT/JP2021/023276

§ 371 Date: Jan. 5, 2023

(30) Foreign Application Priority Data
Jul. 6, 2020 (JP) 2020-116488

(51) Int. Cl. A21D 10/00; A23G 3/48; A23L 7/10; A23L 29/212

(52) U.S. Cl. CPC A21D 10/002; A23G 3/48; A23L 7/198; A23L 29/212

(57) ABSTRACT

A confectionary mix may include: 20 to 60 mass % of a rice flour containing 40 mass % or more of a brown rice flour; and 10 to 50 mass % of a processed starch. The processed starch may be one or more of a crosslinked starch, an etherified crosslinked starch, and an acetylated starch. A method for producing a confectionary may include preparing a dough using the confectionary mix.

### TECHNICAL FIELD

The present invention relates to a confectionary mix and a method for producing confectionary using the mix.

### BACKGROUND ART

As baked confectionary such as a hotcake and an okonomiyaki, and fried confectionary such as donuts and corn dogs, those having a fluffy and soft or crispy texture on surface, chewy, and meltable in mouth are preferred. Many of such a confectionary contain wheat flour as a main raw material. The wheat flour contains starch and gluten, which is a protein characteristic of wheat flour. When a dough containing wheat flour as the main raw material is baked or deep-fried, the gluten is connected in a net-like fashion and solidified, and a structure in which the starch or air is filled between the nets of gluten is formed. Accordingly, the confectionary containing wheat flour as the main raw material can have a preferable texture as described above.

In recent years, food allergy has attracted much attention, and more and more people have to live a dietary life from which an allergen has been removed. Although low-allergic foods and allergen-free foods that contain no food material serving as an allergen are provided, these foods are not necessarily satisfactory in terms of kind and taste. For example, the gluten of wheat flour may cause allergy, and thus confectionary that does not use wheat flour has been produced. However, since the preferable texture of confectionary as described above depends largely on the gluten of wheat flour, the confectionary that does not use wheat flour has a texture different from that of ordinary confectionary.

Rice is consumed as cooked rice, and is also used as a raw material for Japanese confectionary such as a rice dumpling. In recent years, bread and confectionary that uses rice flour have been produced for improving the texture, coping with wheat allergy, and effective use of surplus rice, for example. However, when the rice flour is simply added to bread or confectionary instead of the wheat flour, the preferred texture of gluten as described above is deteriorated.

Various techniques for improving bread and confectionary that uses rice flour have been proposed. Patent Literature 1 describes a method for producing western confectionary by baking a dough obtained by adding the rice flour to a meringue formed by whipping eggs or a whipped cream formed by stirring an oil and water. Patent Literature 2 describes baked confectionary produced using 15 to 25 parts by weight of a grain powder composed of rice flour and/or brown rice flour and having a particle size of 25 to 50 microns, 30 to 50 parts by weight of eggs and 25 to 40 parts by weight of saccharides. Patent Literature 3 describes a powder for takoyaki or okonomiyaki that contains the rice flour having a damaged starch amount of 15 to 45%. Patent Literature 4 describes a premix for takoyaki or okonomiyaki containing glutinous rice flour and/or non-glutinous rice flour as a main component. Patent Literature 5 describes a takoyaki or okonomiyaki flour mix containing 1 to 30 parts by mass of acetylated oxidized starch with respect to 100 parts by mass of cereal flour.

### CITATION LIST

### Patent Literature

Patent Literature 1: JP 2004-141096 A
Patent Literature 2: JP 2018-108078 A
Patent Literature 3: JP 2018-201474 A
Patent Literature 4: JP 2004-000100 A
Patent Literature 5: JP 2013-085524 A

### SUMMARY OF INVENTION

### Technical Problem

It is desirable to provide confectionary having a good texture (for example, fluffy or crispy, and meltable in mouth) like confectionary using normal flour while reducing an amount of wheat flour used or without using wheat flour.

### Solution to Problem

The present inventors found that by using a raw material flour containing a specific amount of a rice flour containing ae brown rice flour and a specific amount of a processed starch such as a crosslinked starch, an etherified crosslinked starch, or an acetylated starch, it is possible to produce confectionary having a good texture like the confectionary using common wheat flour while reducing the amount of wheat flour used or without using wheat flour.

Accordingly, the present invention provides a confectionary mix containing 20 to 60 mass % of rice flour containing 40 mass % or more of a brown rice flour, and 10 to 50 mass % of a processed starch, wherein the processed starch is one or more selected from the group consisting of a crosslinked starch, an etherified crosslinked starch, and an acetylated starch.

The present invention also provides a method for producing confectionary, comprising preparing the dough by using the confectionary mix.

### Advantageous Effects of Invention

According to the present invention, it is possible to provide the confectionary having a good texture (for example, fluffy or crispy, meltable in mouth) like the confectionary using common wheat flour while reducing the amount of wheat flour used, without using wheat flour, or even without using eggs. The confectionary provided in the present invention can be eaten by a person having a wheat allergy, has a good texture, and is satisfactory in quality.

### DESCRIPTION OF EMBODIMENT

The present invention provides a confectionary mix, a method for producing confectionary using the confectionary mix, and confectionary produced using the confectionary mix.

Examples of the confectionary produced using the confectionary mix of the present invention (hereinafter, it is also referred to as the mix of the present invention) include those produced by heating the dough, for example, the baked confectionary and the fried confectionary. The confectionary produced from the mix of the present invention is characterized in that the dough has a fluffy and soft texture. The confectionary may contain food ingredients in a dough. Examples of the baked confectionary include sponge cakes, butter cakes, pancakes, hotcakes, castellas, raisin cakes, fruit cakes, baked donuts, bread, okonomiyaki, takoyaki, and dorayaki. Examples of the fried confectionary include those having a fluffy and soft inside of the dough and a crispy texture on the surface of the dough, for example, fried donuts and corn dogs. However, examples of the confectionary produced from the mix of the present invention are not limited thereto.

The mix of the present invention contains a rice flour as a main raw material. The rice as the raw material of the rice flour is not particularly limited as long as it can be used for food, and both non-glutinous rice and glutinous rice can be used, but the non-glutinous rice is preferable. For example, it is preferable to use rice of a commercially available variety such as (but not limited to) Koshihikari, Hitomebore, Hinohikari, Akitakomachi, Nanatsuboshi, Haenuki, Kinuhikari, Masshigura, Asahi no Yume, Koshiibuki, Tsugaru Roman, and Kirara 397 because a stable quality of rice flour can be obtained. After rice hulls are removed from seeds of the above varieties, a product obtained is brown rice. Milled rice is obtained by further milling brown rice to completely remove bran and germ. In addition, it is also possible to use some rice with bran and germ remaining partially (for example, 70% polished rice, 50% polished rice, and 30% polished rice).

By pulverizing the above rice, the rice flour is obtained. For example, the brown rice flour is obtained by pulverizing the brown rice, and milled rice flour is obtained by pulverizing the milled rice. The rice flour used in the present invention only needs to be generally distributed, and may be, for example, a raw rice flour (for example, a so-called normal milled rice flour, and the brown rice flour) obtained by pulverizing raw rice, or a rice flour obtained by pulverizing rice subjected to heat treatment such as roasting or gelatinization treatment (for example, a roasted milled rice flour, a gelatinized milled rice flour, a roasted brown rice flour, and a gelatinized brown rice flour). Alternatively, the raw rice flour subjected to heat treatment such as roasting or gelatinization treatment may be used. From a viewpoint of the texture of confectionary produced from the mix of the present invention, the rice flour used in the present invention is preferably the raw rice flour. The rice can be pulverized by a known wet pulverization method or dry pulverization method using a commercially available pulverizer, for example, a roll pulverizer, a stamp pulverizer, a water pulverizer, and an impact pin miller. An average particle diameter of the rice flour used in the present invention may be preferably from 10 to 130 μm, more preferably from 20 to 100 μm, further more preferably from 30 to 80 μm, and still more preferably from 50 to 80 μm. The average particle diameter in the present description refers to a volume-based cumulative 50% diameter (D50) obtained from a particle size distribution obtained by a laser diffraction/scattering method as the dry method. Furthermore, the damaged starch amount in the rice flour used in the present invention may be preferably from 0.5 to 25 mass %, and more preferably from 1.5 to 15 mass %. The damaged starch amount can be measured according to an AACC Method 76-31.

A total content of the rice flour in the mix of the present invention may be from 20 to 60 mass % in a total mass of the mix, but is preferably from 25 to 60 mass %, more preferably from 30 to 55 mass %, and still more preferably from 30 to 50 mass %. When the total content of the rice flour is too large or too small, an effect of improving the texture of the confectionary is insufficient.

The rice flour used in the mix of the present invention contains the brown rice flour. The rice flour may contain rice flour other than the brown rice flour, and preferably contains the brown rice flour and the milled rice flour. From the viewpoint of the texture of confectionary, the content of brown rice flour in the whole rice flour contained in the mix of the present invention is preferably 40 mass % or more, and more preferably from 45 to 75 mass %. More specifically, the rice flour may contain 100 to 40 mass % of brown rice flour and 0 to 60 mass % of other rice flour (preferably the milled rice flour). Preferably, the rice flour may contain 45 to 75 mass % of brown rice flour and 25 to 55 mass % of other rice flour (preferably the milled rice flour). When a content ratio of the brown rice flour in the rice flour is small, the texture of the confectionary obtained becomes insufficient. Furthermore, the content of the brown rice flour in the mix of the present invention is preferably 10 mass % or more, more preferably from 15 to 40 mass %, and still more preferably from 20 to 35 mass % in the total mass of the mix. When the content of the brown rice flour is small, the effect of improving the texture of confectionary is insufficient.

For example, a mass ratio of the brown rice flour to the milled rice flour (the brown rice flour:the milled rice flour) in the whole rice flour included in the mix of the present invention is preferably from 100:0 to 40:60, and preferably from 75:25 to 45:55, where the total mass of the rice flour is 100. In a case where the confectionary produced from the mix of the present invention contains no food ingredients in the inside of, for example, general hotcakes, pancakes, and sponge cakes, the mass ratio of the brown rice flour to the milled rice flour is preferably from 75:25 to 40:60, and more preferably from 75:25 to 45:55, where the total mass of the rice flour is 100. On the other hand, in a case of confectionary containing food ingredients therein, since there is an influence of moisture derived from the food ingredients, it is preferable to increase the ratio of the brown rice flour in the mix according to a moisture amount of the food ingredients. For example, when the confectionary produced from the mix of the present invention contains food ingredients having a large amount of moisture inside, such as the okonomiyaki, the mass ratio of the brown rice flour to the milled rice flour is preferably from 95:5 to 50:50, and more preferably from 75:25 to 55:45, where the total mass of the rice flour is 100. By using the brown rice and other rice flour at the above ratio, it is possible to produce the confectionary having a good texture like a confectionary made from wheat flour, even when wheat flour is used.

The mix of the present invention further contains a processed starch in addition to the rice flour. The processed starch is obtained by subjecting a raw material starch (an unprocessed starch) to a chemical or physical processing treatment. The kind of the raw material starch of the processed starch is not particularly limited as long as it can be used for food, and may be, for example, a wheat starch, a rice starch, a tapioca starch, a potato starch, or a corn starch, and any one of these starches or a mixture of two or more thereof can be used. Among them, the rice starch or the tapioca starch is preferable. Furthermore, the processing treatment of the raw material starch is not particularly limited, and examples thereof include an oxidation treatment, an esterification treatment, an ether treatment, an acid treatment, a crosslinking treatment, an oil/fat processing treatment, and a gelatinization treatment, and any one of these treatments or a combination of two or more thereof can be performed. The processed starch is preferably a crosslinked starch, an etherified crosslinked starch, an acetylated starch, or a combination thereof. Examples of the crosslinked starch include a phosphate crosslinked starch. Examples of the etherified crosslinked starches include a hydroxypropylated phosphate crosslinked starch. Examples of the acetylated starch include an acetic acid starch, and does not include the acetylated oxidized starch.

The content of the processed starch in the mix of the present invention may be from 10 to 50 mass % in the total mass of the mix, but is preferably from 15 to 45 mass % and more preferably from 20 to 40 mass %. When the content of the processed starch is too large or too small, the effect of improving the texture of confectionary is insufficient.

From the viewpoint of texture improvement, the mix of the present invention preferably further contains one or more selected from an alginic acid and a cellulose ether in addition to the rice flour and the processed starch. As the alginic acid, any kind of alginic acid that can be used for food and has a solubility in water may be used, and examples thereof include alginic acid monovalent salts such as a sodium alginate and a potassium alginate, and an alginic acid ester. As the cellulose ether, any kind of cellulose ether that can be used for food and has the solubility in water may be used, and examples thereof include an alkyl cellulose, a hydroxyalkyl cellulose, and a hydroxyalkylalkyl cellulose. The alginic acid and the cellulose ether mentioned above can be used alone or in combination of two or more thereof.

A total content of the alginic acid and the cellulose ether in the mix of the present invention is preferably from 0.1 to 10 mass %, more preferably from 0.3 to 5 mass %, and still more preferably from 0.5 to 2 mass % in the total mass of the mix. When the total content is too large or too small, the effect of improving the texture of confectionary is insufficient.

In the mix of the present invention, in addition to the above components (the rice flour, the processed starch, the alginic acid, and the cellulose ether), other raw materials that can be usually used for the confectionary mix, for example, a cereal flour other than the rice flour, an unprocessed starch, an saccharides, proteins, salt, thickeners, leavening agents, and flavors, can be blended as necessary. The content of these other raw materials is preferably about 0 to 50 mass % with respect to the total mass of the confectionary mix of the present invention. From the viewpoint of allergen removal, preferably, the mix of the present invention does not contain wheat flour and gluten, or does not contain egg components (for example, whole egg powder, egg white powder, egg yellow powder). More preferably, the mix of the invention is free of wheat flour, gluten and egg components.

It is possible to produce the confectionary using the confectionary mix of the present invention as a raw material flour. The method for producing the confectionary using the mix of the present invention is basically the same as the method for producing the confectionary using a general confectionary mix. In other words, the method for producing the confectionary using the mix of the present invention basically includes preparing the dough by using the mix of the present invention.

The dough for confectionary is generally roughly divided into a clay-like dough and a liquid dough (a batter), and the dough prepared by the method of the present invention may be any of these doughs. Preferably, the dough prepared in the method of the present invention is a batter. All of these doughs can be prepared by adding a liquid to the mix of the present invention and mixing the mix obtained. As the liquid, those usually used for preparing a dough, for example, water, an aqueous solution, milk, soy milk, egg liquid, fresh cream, a liquid fat and oil, an oil solution, an emulsion, a liquid seasoning, or a mixture of two or more thereof can be used. When desired, the food ingredients may be added to the dough. On the other hand, from the viewpoint of allergen removal, the dough does not contain any wheat flour and gluten, or does not contain egg components (for example, whole eggs, egg whites, and egg yolks). More preferably, the dough does not contain any wheat flour, gluten and egg components.

The amount of the liquid to be added to the mix of the present invention at the time of dough preparation may be appropriately adjusted, for example, according to the kind of confectionary to be produced, and is preferably from 30 to 300 parts by mass with respect to 100 parts by mass of the mix. When the food ingredients are added to the dough, the amount of the liquid to be added may be adjusted in consideration of the moisture coming out of the food ingredients. For example, when preparing the dough, the amount of the liquid to be added is preferably from about 30 to 65 parts by mass with respect to 100 parts by mass of the mix of the present invention, and when preparing the batter, the amount of the liquid to be added is preferably from about 66 to 300 parts by mass with respect to 100 parts by mass of the mix of the present invention, and more preferably from about 66 to 200 parts by mass. Alternatively, the amount of the liquid to be added is preferably from about 86 to 200 parts by mass with respect to 100 parts by mass of the mix of the present invention in a case of preparing the batter for baked confectionary, and is preferably from about 66 to 140 parts by mass with respect to 100 parts by mass of the mix of the present invention in a case of preparing the batter for fried confectionary.

Next, the obtained dough is molded as necessary, and then heated to produce the confectionary. Preferably, the dough prepared by using the mix of the present invention is foamed physically or using the leavening agents to produce the confectionary having air bubbles inside a heated dough. Examples of means for heating include baking and deep-frying. Preferably, the confectionary produced by the method of the present invention is baked confectionary or fried confectionary.

The mix of the present invention can be used for the production of various kinds of confectionary, such as those containing no food ingredients therein and those containing food ingredients therein. In one example, a batter-like dough prepared from the mix of the present invention is dropped onto a heated plate or a frying pan, spread, and baked to produce the pancakes or the hotcakes. In another example, cakes are produced by putting the batter-like dough prepared from the mix of the present invention into a mold and then baking it. In another example, the dough prepared from the mix of the present invention is molded and baked or deep-fried to produce the donuts. In another example, the dough containing the mix of the present invention and the food ingredients such as cabbage is baked on the heated plate or the frying pan to produce the okonomiyaki. In another example, the batter-like dough prepared from the mix of the present invention is attached to a sausage skewered on a bamboo stick so that the sausage is wrapped by the batter-like dough, and deep-fried to produce the corn dogs.

### EXAMPLES

Hereinafter, the present invention will be described in more detail with reference to the embodiments, but the present invention is not limited to the following examples.

The raw materials used for producing the confectionary in the following examples are shown below. In addition, the average particle diameter of the rice flour and wheat flour represents a volume-based cumulative 50% diameter (D50) measured by a dry standard method using Microtrac MT3000.
Rice flour: the milled rice flour (a rice flour P: Fresh Food Service Co., Ltd.)
   Brown rice flour (a rice flour PE: Fresh Food Service Co., Ltd.)
   Roasted brown rice flour (a brown rice flour (roasted): Namisato Corporation)
Flour: a soft wheat flour (violet: NISSIN FOODS HOLDINGS CO., LTD.)
Unprocessed starch: a corn starch (manufactured by TOMIZAWA SHOUTEN)
Processed starch 1: a hydroxypropylated phosphate crosslinked tapioca starch (Matsutani Yuri 8, Matsutani Chemical Industry Co., Ltd.)
Processed starch 2: a phosphate-crosslinked tapioca starch (pinebake CC: Matsutani Chemical Industry Co., Ltd.)
Processed starch 3: an acetic acid starch (Nisshoku MT-01: NIHON SHOKUHIN KAKO CO., LTD.)
Processed starch 4: the acetylated oxidized starch (Gelcol SP-2: Siam Starch Co., Ltd.)
Alginic acid ester: the alginic acid ester (KIMICA Corporation)
Cellulose ether: a hydroxypropyl methyl cellulose (Shin-Etsu Chemical Co., Ltd.)
Sugar
Leavening agents
Xanthan gum
Guar gum
Vanilla flavor

### Test Example 1: Hotcakes

The raw materials shown in Tables 1 to 7 were appropriately mixed to prepare the confectionary mix. In Table 1, the kind of starch was changed. In Table 2, the content of rice flour was changed. In Tables 3 and 4, the content ratio of the brown rice flour in the rice flour and the content of the brown rice flour in the mix were changed. In Table 5, the content of the processed starch was changed. In Table 6, the content of alginic acid ester or the cellulose ether was changed. In Table 7, a particle diameter of the rice flour was changed.

Using the obtained confectionary mix, the hotcakes were produced. To 200 parts by mass of the confectionary mix, were added 50 parts by mass of liquid eggs (the whole eggs) and 130 parts by mass of milk, and the mixture was well stirred to obtain the batter-like dough. The obtained dough was dropped on a hot plate heated to 170° C., spread, and baked for 3 minutes, then turned upside down, and further baked for 2 minutes to produce the hotcakes. The texture (fluffy and meltable in mouth) of the produced hotcakes was evaluated by 10 trained panelists according to the following evaluation criteria, and an average score of the evaluations of 10 panelists was obtained. The results are shown in Table 1 to 7.

<Evaluation Criteria of Hotcakes>

(Fluffy Texture)
5 points: extremely good in softness and fluffiness.
4 points: favorable softness and fluffiness.
3 points: fluffy but slightly hard, and almost good.
2 points: less fluffy, slightly hard or slightly dry, and poor.
1 point: not fluffy, and hard or dry, and extremely poor.

(Meltableness in Mouth)
5 points: very good meltableness in mouth and very good.
4 points: good meltableness in mouth and good.
3 points: a bit meltableness in mouth and almost good.
2 points: poor meltableness in mouth, slightly sticky, and poor.
1 point: very poor meltableness in mouth, sticky or dumpling-like, and very poor.

TABLE 1

| | | | | | | | Refer- |
|---|---|---|---|---|---|---|---|
| | | | | | Comparison | | ence |
| Confectionary mix | Production Examples | | | | Examples | | Exam- |
| (mass %) | 1-1 | 1-2 | 1-3 | 1-4 | 1-1 | 1-2 | ple |
| Milled rice flour | 15 | 15 | 15 | 15 | 15 | 15 | |
| Brown rice flour | 15 | 15 | 15 | | 15 | 15 | |
| Roasted brown rice | | | | 15 | | | |
| flour | | | | | | | |
| Wheat flour | | | | | | | 50 |
| Average particle | 58 | 58 | 58 | 58 | 58 | 58 | 24 |
| diameter (μm) | | | | | | | |
| Processed starch 1 | 30 | | | 30 | | | 30 |
| Processed starch 2 | | 30 | | | | | |
| Processed starch 3 | | | 30 | | | | |
| Processed starch 4 | | | | | 30 | | |
| Corn starch | 20 | 20 | 20 | 20 | 20 | 50 | |
| Sugar | 16.5 | 16.5 | 16.5 | 16.5 | 16.5 | 16.5 | 16.5 |
| Leavening agent | 3 | 3 | 3 | 3 | 3 | 3 | 3 |
| Xanthan gum | 0.2 | 0.2 | 0.2 | 0.2 | 0.2 | 0.2 | 0.2 |
| Vanilla flavor | 0.3 | 0.3 | 0.3 | 0.3 | 0.3 | 0.3 | 0.3 |
| Total | 100 | 100 | 100 | 100 | 100 | 100 | 100 |
| Evaluation | | | | | | | |
| Fluffiness | 4.2 | 3.9 | 4.0 | 4.0 | 3.2 | 2.8 | 5.0 |
| Meltableness | 4.3 | 4.2 | 3.7 | 3.7 | 2.8 | 2.5 | 5.0 |
| in mouth | | | | | | | |

TABLE 2

| | Comparison | | | | | | | | Comparison |
|---|---|---|---|---|---|---|---|---|---|
| Confectionary | Example | Production Examples | | | | | | | Example |
| mix (mass %) | 2-1 | 2-1 | 2-2 | 1-1 | 2-3 | 2-4 | 2-5 | 2-6 | 2-2 |
| Milled rice flour | 7.5 | 10 | 12.5 | 15 | 20 | 25 | 30 | 10 | 35 |
| Brown rice flour | 7.5 | 10 | 12.5 | 15 | 20 | 25 | 30 | | 35 |
| Roasted brown | | | | | | | | 10 | |
| rice flour | | | | | | | | | |
| Average particle | 58 | 58 | 58 | 58 | 58 | 58 | 58 | 58 | 58 |
| diameter (μm) | | | | | | | | | |
| Processed starch 1 | 30 | 30 | 30 | 30 | 30 | 30 | 20 | 30 | 10 |
| Corn starch | 35 | 30 | 25 | 20 | 10 | | | 30 | |
| Sugar | 16.5 | 16.5 | 16.5 | 16.5 | 16.5 | 16.5 | 16.5 | 16.5 | 16.5 |
| Leavening agent | 3 | 3 | 3 | 3 | 3 | 3 | 3 | 3 | 3 |
| Xanthan gum | 0.2 | 0.2 | 0.2 | 0.2 | 0.2 | 0.2 | 0.2 | 0.2 | 0.2 |
| Vanilla flavor | 0.3 | 0.3 | 0.3 | 0.3 | 0.3 | 0.3 | 0.3 | 0.3 | 0.3 |
| Total | 100 | 100 | 100 | 100 | 100 | 100 | 100 | 100 | 100 |
| Evaluation | | | | | | | | | |
| Fluffiness | 2.6 | 3.2 | 3.5 | 4.2 | 4.2 | 4.2 | 4.1 | 3.1 | 3.5 |
| Meltableness in mouth | 3.2 | 3.6 | 3.8 | 4.3 | 4.0 | 3.9 | 3.4 | 3.2 | 2.7 |

TABLE 3

| | | | | | | | | | | | Comparison | | |
|---|---|---|---|---|---|---|---|---|---|---|---|---|---|
| Confectionary | Production Examples | | | | | | | | | | Examples | | |
| mix (mass %) | 3-1 | 3-2 | 3-3 | 3-4 | 3-5 | 3-6 | 2-4 | 3-7 | 3-8 | 3-9 | 3-1 | 3-2 | 3-3 |
| Milled rice | | 2.5 | 7.5 | 12.5 | 17.5 | 22.5 | 25 | 27.5 | 30 | | 35 | 40 | 50 |
| flour | | | | | | | | | | | | | |
| Brown rice | 50 | 47.5 | 42.5 | 37.5 | 32.5 | 27.5 | 25 | 22.5 | 20 | | 15 | 10 | |
| flour | | | | | | | | | | | | | |
| Roasted | | | | | | | | | | | | | |
| brown rice | | | | | | | | | | 50 | | | |
| flour 41 | | | | | | | | | | | | | |
| Milled rice | 0:100 | 5:95 | 15:85 | 25:75 | 35:65 | 45:55 | 50:50 | 55:45 | 60:40 | 0:100 | 70:30 | 80:20 | 100:0 |
| flour:Brown | | | | | | | | | | | | | |
| rice flour | | | | | | | | | | | | | |
| Average particle | 58 | 58 | 58 | 58 | 58 | 58 | 58 | 58 | 58 | 58 | 58 | 58 | 58 |
| diameter (μm) | | | | | | | | | | | | | |
| Processed | 30 | 30 | 30 | 30 | 30 | 30 | 30 | 30 | 30 | 30 | 30 | 30 | 30 |
| starch 1 | | | | | | | | | | | | | |
| Sugar | 16.5 | 16.5 | 16.5 | 16.5 | 16.5 | 16.5 | 16.5 | 16.5 | 16.5 | 16.5 | 16.5 | 16.5 | 16.5 |
| Leavening | 3 | 3 | 3 | 3 | 3 | 3 | 3 | 3 | 3 | 3 | 3 | 3 | 3 |
| agent | | | | | | | | | | | | | |
| Xanthan gum | 0.2 | 0.2 | 0.2 | 0.2 | 0.2 | 0.2 | 0.2 | 0.2 | 0.2 | 0.2 | 0.2 | 0.2 | 0.2 |
| Vanilla flavor | 0.3 | 0.3 | 0.3 | 0.3 | 0.3 | 0.3 | 0.3 | 0.3 | 0.3 | 0.3 | 0.3 | 0.3 | 0.3 |
| Total | 100 | 100 | 100 | 100 | 100 | 100 | 100 | 100 | 100 | 100 | 100 | 100 | 100 |
| Evaluation | | | | | | | | | | | | | |
| Fluffiness | 3.3 | 3.4 | 3.6 | 4.0 | 4.1 | 4.2 | 4.2 | 4.2 | 4.1 | 3.0 | 3.5 | 1.5 | 2.2 |
| Meltableness | 3.9 | 3.9 | 3.9 | 4.1 | 4.0 | 3.9 | 3.9 | 3.8 | 3.6 | 3.1 | 2.6 | 1.9 | 1.4 |
| in mouth | | | | | | | | | | | | | |

TABLE 4

| | Comparison | | | | | | | Comparison | |
|---|---|---|---|---|---|---|---|---|---|
| Confectionary mix | Example | Production Examples | | | | | | Examples | |
| (mass %) | 4-1 | 4-1 | 2-3 | 4-2 | 4-3 | 4-4 | 4-5 | 4-2 | 4-3 |
| Milled rice flour | 20 | 20 | 20 | 20 | 20 | 20 | 20 | 20 | 20 |
| Brown rice flour | 10 | 15 | 20 | 25 | 30 | 35 | 40 | 50 | 60 |
| Milled rice | 67:33 | 57:43 | 50:50 | 44:56 | 40:60 | 36:64 | 33:67 | 29:71 | 25:75 |
| flour:Brown rice | | | | | | | | | |
| flour | | | | | | | | | |
| Average particle | 58 | 58 | 58 | 58 | 58 | 58 | 58 | 58 | 58 |
| diameter (μm) | | | | | | | | | |
| Processed starch 1 | 30 | 30 | 30 | 30 | 30 | 25 | 20 | 10 | |
| Corn starch | 20 | 15 | 10 | 5 | | | | | |
| Sugar | 16.5 | 16.5 | 16.5 | 16.5 | 16.5 | 16.5 | 16.5 | 16.5 | 16.5 |
| Leavening agent | 3 | 3 | 3 | 3 | 3 | 3 | 3 | 3 | 3 |
| Xanthan gum | 0.2 | 0.2 | 0.2 | 0.2 | 0.2 | 0.2 | 0.2 | 0.2 | 0.2 |
| Vanilla flavor | 0.3 | 0.3 | 0.3 | 0.3 | 0.3 | 0.3 | 0.3 | 0.3 | 0.3 |
| Total | 100 | 100 | 100 | 100 | 100 | 100 | 100 | 100 | 100 |
| Evaluation | | | | | | | | | |
| Fluffiness | 3.2 | 3.8 | 4.2 | 4.3 | 4.2 | 4.1 | 4.1 | 3.4 | 2.9 |
| Meltableness in | 2.6 | 3.2 | 4.0 | 4.2 | 4.1 | 3.8 | 3.7 | 2.3 | 1.9 |
| mouth | | | | | | | | | |

TABLE 5

| | Comparison | | | | | | | | | Comparison |
|---|---|---|---|---|---|---|---|---|---|---|
| Confectionary mix | Example | Production Examples | | | | | | | | Example |
| (mass %) | 5-1 | 5-1 | 5-2 | 5-3 | 5-4 | 5-5 | 5-6 | 5-7 | 5-8 | 5-2 |
| Milled rice flour | 20 | 20 | 20 | 20 | 20 | 20 | 20 | 20 | 20 | 15 |
| Brown rice flour | 20 | 20 | 20 | 20 | 20 | 20 | 20 | 20 | 20 | 15 |
| Average particle | 58 | 58 | 58 | 58 | 58 | 58 | 58 | 58 | 58 | 58 |
| diameter (μm) | | | | | | | | | | |
| Processed starch 1 | 5 | 10 | 15 | 20 | 25 | 35 | 40 | 45 | 50 | 60 |
| Corn starch | 35 | 30 | 25 | 20 | 15 | 5 | | | | |
| Sugar | 16.5 | 16.5 | 16.5 | 16.5 | 16.5 | 16.5 | 16.5 | 11.5 | 6.5 | 6.5 |
| Leavening agent | 3 | 3 | 3 | 3 | 3 | 3 | 3 | 3 | 3 | 3 |
| Xanthan gum | 0.2 | 0.2 | 0.2 | 0.2 | 0.2 | 0.2 | 0.2 | 0.2 | 0.2 | 0.2 |
| Vanilla flavor | 0.3 | 0.3 | 0.3 | 0.3 | 0.3 | 0.3 | 0.3 | 0.3 | 0.3 | 0.3 |
| Total | 100 | 100 | 100 | 100 | 100 | 100 | 100 | 100 | 100 | 100 |
| Evaluation | | | | | | | | | | |
| Fluffiness | 2.5 | 3.8 | 3.9 | 4.1 | 4.2 | 4.1 | 4.0 | 3.6 | 3.3 | 3.0 |
| Meltableness in | 3.7 | 3.5 | 3.8 | 4.0 | 4.2 | 4.1 | 4.0 | 4.0 | 4.0 | 2.6 |
| mouth | | | | | | | | | | |

TABLE 6

| Confectionary mix | Production Examples | | | | | | | | | |
|---|---|---|---|---|---|---|---|---|---|---|
| (mass %) | 2-4 | 6-1 | 6-2 | 6-3 | 6-4 | 6-5 | 6-6 | 6-7 | 6-8 | 6-9 |
| Milled rice flour | 25 | 25 | 25 | 25 | 25 | 25 | 25 | 25 | 25 | 25 |
| Brown rice flour | 25 | 25 | 25 | 25 | 25 | 25 | 25 | 25 | 25 | 25 |
| Average particle | 58 | 58 | 58 | 58 | 58 | 58 | 58 | 58 | 58 | 58 |
| diameter (μm) | | | | | | | | | | |
| alginic acid ester | | 0.1 | 0.3 | 0.5 | 2 | 5 | 10 | 15 | | |
| Cellulose ether | | | | | | | | | 0.5 | 2 |
| Processed starch 1 | 30 | 29.9 | 29.7 | 29.5 | 28 | 25 | 20 | 15 | 29.5 | 28 |
| Sugar | 16.5 | 16.5 | 16.5 | 16.5 | 16.5 | 16.5 | 16.5 | 16.5 | 16.5 | 16.5 |
| Leavening agent | 3 | 3 | 3 | 3 | 3 | 3 | 3 | 3 | 3 | 3 |
| Xanthan gum | 0.2 | 0.2 | 0.2 | 0.2 | 0.2 | 0.2 | 0.2 | 0.2 | 0.2 | 0.2 |
| Vanilla flavor | 0.3 | 0.3 | 0.3 | 0.3 | 0.3 | 0.3 | 0.3 | 0.3 | 0.3 | 0.3 |
| Total | 100 | 100 | 100 | 100 | 100 | 100 | 100 | 100 | 100 | 100 |
| Evaluation | | | | | | | | | | |
| Fluffiness | 4.2 | 4.4 | 4.5 | 4.7 | 4.6 | 4.4 | 4.3 | 4.0 | 4.7 | 4.6 |
| Meltableness in | 3.9 | 4.2 | 4.4 | 4.6 | 4.7 | 4.5 | 4.3 | 4.0 | 4.5 | 4.7 |
| mouth | | | | | | | | | | |

TABLE 7

| | Production Examples | | | | |
|---|---|---|---|---|---|
| Confectionary mix (mass %) | 7-1 | 2-4 | 7-2 | 7-3 | 7-4 |
| Milled rice flour | 25 | 25 | 25 | 25 | 25 |
| Brown rice flour | 25 | 25 | 25 | 25 | 25 |
| Average particle diameter (μm) | 24 | 58 | 80 | 100 | 150 |
| Processed starch 1 | 30 | 30 | 30 | 30 | 30 |
| Sugar | 16.5 | 16.5 | 16.5 | 16.5 | 16.5 |
| Leavening agent | 3 | 3 | 3 | 3 | 3 |
| Xanthan gum | 0.2 | 0.2 | 0.2 | 0.2 | 0.2 |
| Vanilla flavor | 0.3 | 0.3 | 0.3 | 0.3 | 0.3 |
| Total | 100 | 100 | 100 | 100 | 100 |
| Evaluation | | | | | |
| Fluffiness | 3.7 | 4.2 | 4.1 | 3.9 | 3.3 |
| Meltableness in mouth | 3.8 | 3.9 | 4.0 | 4.0 | 3.7 |

### Test Example 2: Hotcakes without Using Eggs

Hotcakes were produced and evaluated according to the same procedure as in Test Example 1 except that the liquid eggs added to the confectionary mix was replaced with water. The results are shown in Table 8 together with Production Examples 2-1, 1-1 and 2-5.

TABLE 8

| Confectionary mix | Production Examples | | | Production Examples | | |
|---|---|---|---|---|---|---|
| (mass %) | 2-1 | 1-1 | 2-5 | 8-1 | 8-2 | 8-3 |
| Milled rice flour | 10 | 15 | 30 | 10 | 15 | 30 |
| Brown rice flour | 10 | 15 | 30 | 10 | 15 | 30 |
| Average particle | 58 | 58 | 58 | 58 | 58 | 58 |
| diameter (μm) | | | | | | |
| Processed starch 1 | 30 | 30 | 20 | 30 | 30 | 20 |
| Corn starch | 30 | 20 | | 30 | 20 | |
| Sugar | 16.5 | 16.5 | 16.5 | 16.5 | 16.5 | 16.5 |
| Leavening agent | 3 | 3 | 3 | 3 | 3 | 3 |
| Xanthan gum | 0.2 | 0.2 | 0.2 | 0.2 | 0.2 | 0.2 |
| Vanilla flavor | 0.3 | 0.3 | 0.3 | 0.3 | 0.3 | 0.3 |
| Total | 100 | 100 | 100 | 100 | 100 | 100 |
| Use of liquid | Yes | | | No | | |
| eggs or not | | | | | | |
| Evaluation | | | | | | |
| Fluffiness | 3.2 | 4.2 | 4.1 | 3.1 | 3.7 | 3.8 |
| Meltableness | 3.6 | 4.3 | 3.4 | 3.4 | 3.8 | 3.2 |
| in mouth | | | | | | |

### Test Example 3: Okonomiyaki

The raw materials shown in Tables 9 to 15 were appropriately mixed to prepare the confectionary mix. In Table 9, the kind of starch was changed. In Table 10, the content of rice flour was changed. In Tables 11 and 12, the content ratio of brown rice flour in the rice flour and the content of brown rice flour in the mix were changed. In Table 13, the content of the processed starch was changed. In Table 14, the content of alginic acid ester or the cellulose ether was changed. In Table 15, the particle diameter of the rice flour was changed.

The obtained confectionary mix was used to produce the okonomiyaki. To 50 parts by mass of the confectionary mix, 35 parts by mass of water, 15 parts by mass of the liquid eggs (the whole eggs), and the food ingredients were added and stirred to obtain the batter-like dough containing the food ingredients. As the food ingredients, 5 parts by mass of red pickled ginger, 25 parts by mass of cut pork pieces, and 130 parts by mass of shredded cabbage were used. The obtained dough for okonomiyaki was spread in a disk shape with a thickness of 2.5 cm on an iron plate heated to 180° C. When the air bubbles appeared on the surface, the surface was reversed, and firing was performed while the surface was turned back for several times until both surfaces became light brown and the entire surface was cooked, thereby producing the okonomiyaki. The texture (fluffy and meltable in mouth) of the produced okonomiyaki was evaluated by 10 trained panelists according to the following evaluation criteria, and the average score of the evaluations of 10 panelists was obtained. The results are shown in Tables 9 to 15.

<Evaluation Criteria of Okonomiyaki>

(Fluffy Texture)
5 points: extremely good in softness and fluffiness.
4 points: favorable softness and fluffiness.
3 points: fluffy but slightly hard, and almost good.
2 points: less fluffy, slightly hard or slightly dry, and poor.
1 point: not fluffy, and hard or dry, and extremely poor.

(Meltableness in Mouth)
5 points: very good meltableness in mouth and very good.
4 points: good meltableness in mouth and good.
3 points: a bit meltableness in mouth and almost good.
2 points: poor meltableness in mouth, slightly sticky, and poor.
1 point: very poor meltableness in mouth, sticky or dumpling-like, and very poor.

TABLE 9

| | | | | | | Comparison | | |
|---|---|---|---|---|---|---|---|---|
| Confectionary mix | Production Examples | | | | | Examples | | Reference |
| (mass %) | 9-1 | 9-2 | 9-3 | 9-4 | 9-5 | 9-1 | 9-2 | Example |
| Milled rice flour | 15 | 15 | 15 | 25 | 15 | 25 | 25 | |
| Brown rice flour | 15 | 15 | 15 | 25 | | 25 | 25 | |
| Roasted brown rice | | | | | 15 | | | |
| flour | | | | | | | | |
| Wheat flour | | | | | | | | 60 |
| Average particle | 58 | 58 | 58 | 58 | 58 | 58 | 58 | 24 |
| diameter (μm) | | | | | | | | |
| Processed starch 1 | 30 | | | 40 | 30 | | | 30 |
| Processed starch 2 | | 30 | | | | | | |
| Processed starch 3 | | | 30 | | | | | |
| Processed starch 4 | | | | | | 40 | | |
| Corn starch | 30 | 30 | 30 | | 30 | | 40 | |
| Seasoning | 6.5 | 6.5 | 6.5 | 6.5 | 6.5 | 6.5 | 6.5 | 6.5 |
| Leavening agent | 3 | 3 | 3 | 3 | 3 | 3 | 3 | 3 |
| Guar gum | 0.5 | 0.5 | 0.5 | 0.5 | 0.5 | 0.5 | 0.5 | 0.5 |
| Total | 100 | 100 | 100 | 100 | 100 | 100 | 100 | 100 |
| Evaluation | | | | | | | | |
| Fluffiness | 4.0 | 3.7 | 3.7 | 4.0 | 3.8 | 2.1 | 1.5 | 5.0 |
| Meltableness in | 4.2 | 4.3 | 3.8 | 3.8 | 3.6 | 1.2 | 1.2 | 5.0 |
| mouth | | | | | | | | |

TABLE 10

| | Comparison | | | | | | | | Comparison |
|---|---|---|---|---|---|---|---|---|---|
| Confectionary mix | Example | Production Examples | | | | | | | Example |
| (mass %) | 10-1 | 10-1 | 10-2 | 9-1 | 10-3 | 10-4 | 10-5 | 10-6 | 10-2 |
| Milled rice flour | 7.5 | 10 | 12.5 | 15 | 25 | 27.5 | 30 | 10 | 35 |
| Brown rice flour | 7.5 | 10 | 12.5 | 15 | 25 | 27.5 | 30 | | 35 |
| Roasted brown rice | | | | | | | | 10 | |
| flour | | | | | | | | | |
| Average particle | 58 | 58 | 58 | 58 | 58 | 58 | 58 | 58 | 58 |
| diameter (μm) | | | | | | | | | |
| Processed starch 1 | 30 | 30 | 30 | 30 | 30 | 30 | 30 | 30 | 20 |
| Corn starch | 45 | 40 | 35 | 30 | 10 | 5 | | 40 | |
| Seasoning | 6.5 | 6.5 | 6.5 | 6.5 | 6.5 | 6.5 | 6.5 | 6.5 | 6.5 |
| Leavening agent | 3 | 3 | 3 | 3 | 3 | 3 | 3 | 3 | 3 |
| Guar gum | 0.5 | 0.5 | 0.5 | 0.2 | 0.5 | 0.5 | 0.5 | 0.5 | 0.5 |
| Total | 100 | 100 | 100 | 100 | 100 | 100 | 100 | 100 | 100 |
| Evaluation | | | | | | | | | |
| Fluffiness | 1.7 | 3.0 | 3.4 | 4.0 | 4.0 | 4.1 | 3.8 | 2.9 | 3.3 |
| Meltableness in | 3.2 | 3.6 | 3.9 | 4.2 | 4.0 | 3.5 | 3.3 | 3.2 | 2.6 |
| mouth | | | | | | | | | |

TABLE 11

| | Production | | | | | | | | | | Comparison |
|---|---|---|---|---|---|---|---|---|---|---|---|
| Confectionary | Example | | | | | | | | | | Example |
| mix (mass %) | 11-1 | 11-2 | 11-3 | 11-4 | 11-5 | 11-6 | 9-4 | 11-7 | 11-8 | 11-9 | 11-1 |
| Milled rice flour | | 2.5 | 7.5 | 12.5 | 17.5 | 22.5 | 25 | 27.5 | 30 | | 35 |
| Brown rice flour | 50 | 47.5 | 42.5 | 37.5 | 32.5 | 27.5 | 25 | 22.5 | 20 | | 15 |
| Roasted brown | | | | | | | | | | 50 | |
| rice flour | | | | | | | | | | | |
| Milled rice | 0:100 | 5:95 | 15:85 | 25:75 | 35:65 | 45:55 | 50:50 | 55:45 | 60:40 | 0:100 | 70:30 |
| flour:Brown | | | | | | | | | | | |
| rice flour | | | | | | | | | | | |
| Average particle | 58 | 58 | 58 | 58 | 58 | 58 | 58 | 58 | 58 | 58 | 58 |
| diameter (μm) | | | | | | | | | | | |
| Processed | 40 | 40 | 40 | 40 | 40 | 40 | 40 | 40 | 40 | 40 | 40 |
| starch 1 | | | | | | | | | | | |
| Seasoning | 6.5 | 6.5 | 6.5 | 6.5 | 6.5 | 6.5 | 6.5 | 6.5 | 6.5 | 6.5 | 6.5 |
| Leavening | 3 | 3 | 3 | 3 | 3 | 3 | 3 | 3 | 3 | 3 | 3 |
| agent | | | | | | | | | | | |
| Guar gum | 0.5 | 0.5 | 0.5 | 0.5 | 0.5 | 0.5 | 0.5 | 0.5 | 0.5 | 0.5 | 0.5 |
| Total | 100 | 100 | 100 | 100 | 100 | 100 | 100 | 100 | 100 | 100 | 100 |
| Evaluation | | | | | | | | | | | |
| Fluffiness | 3.6 | 3.8 | 3.9 | 4.1 | 4.2 | 4.1 | 4.0 | 3.9 | 3.8 | 3.3 | 3.2 |
| Meltableness | 4.1 | 4.2 | 4.2 | 4.2 | 4.1 | 4.0 | 3.8 | 3.6 | 3.4 | 3.3 | 2.3 |

TABLE 12

| | Comparison | | | | | | | Comparison | |
|---|---|---|---|---|---|---|---|---|---|
| Confectionary mix | Examples | Production Examples | | | | | | Examples | |
| (mass %) | 12-1 | 12-1 | 12-2 | 12-3 | 12-4 | 12-5 | 12-6 | 12-2 | 12-3 |
| Milled rice flour | 20 | 20 | 20 | 20 | 20 | 20 | 20 | 20 | 20 |
| Brown rice flour | 10 | 15 | 20 | 25 | 30 | 35 | 40 | 50 | 60 |
| Milled rice | 67:33 | 57:43 | 50:50 | 44:56 | 40:60 | 36:64 | 33:67 | 29:71 | 25:75 |
| flour:Brown rice | | | | | | | | | |
| flour | | | | | | | | | |
| Average particle | 58 | 58 | 58 | 58 | 58 | 58 | 58 | 58 | 58 |
| diameter (μm) | | | | | | | | | |
| Processed starch 1 | 30 | 30 | 30 | 30 | 30 | 30 | 30 | 20 | 10 |
| Corn starch | 30 | 25 | 20 | 15 | 10 | 5 | | | |
| Seasoning | 6.5 | 6.5 | 6.5 | 6.5 | 6.5 | 6.5 | 6.5 | 6.5 | 6.5 |
| Leavening agent | 3 | 3 | 3 | 3 | 3 | 3 | 3 | 3 | 3 |
| Guar gum | 0.5 | 0.5 | 0.5 | 0.5 | 0.5 | 0.5 | 0.5 | 0.5 | 0.5 |
| Total | 100 | 100 | 100 | 100 | 100 | 100 | 100 | 100 | 100 |
| Evaluation | | | | | | | | | |
| Fluffiness | 3.2 | 3.7 | 3.9 | 4.0 | 4.2 | 4.0 | 3.9 | 3.1 | 2.7 |
| Meltableness in | 2.5 | 3.2 | 3.9 | 4.0 | 4.1 | 3.9 | 3.6 | 2.4 | 2.0 |
| mouth | | | | | | | | | |

TABLE 13

| | | | | | | | | | Comparison | |
|---|---|---|---|---|---|---|---|---|---|---|
| Confectionary mix | Production Examples | | | | | | | | Examples | |
| (mass %) | 13-1 | 13-2 | 13-3 | 13-4 | 13-5 | 13-6 | 13-7 | 13-8 | 13-1 | 13-2 |
| Milled rice flour | 20 | 20 | 20 | 20 | 20 | 20 | 20 | 20 | 20 | 15 |
| Brown rice flour | 20 | 20 | 20 | 20 | 20 | 20 | 20 | 20 | 20 | 15 |
| Average particle | 58 | 58 | 58 | 58 | 58 | 58 | 58 | 58 | 58 | 58 |
| diameter (μm) | | | | | | | | | | |
| Processed starch 1 | 10 | 15 | 20 | 25 | 35 | 40 | 45 | 50 | 5 | 60 |
| Corn starch | 40 | 35 | 30 | 25 | 15 | 10 | 5 | | 45 | |
| Seasoning | 6.5 | 6.5 | 6.5 | 6.5 | 6.5 | 6.5 | 6.5 | 6.5 | 6.5 | 6.5 |
| Leavening agent | 3 | 3 | 3 | 3 | 3 | 3 | 3 | 3 | 3 | 3 |
| Guar gum | 0.5 | 0.5 | 0.5 | 0.5 | 0.5 | 0.5 | 0.5 | 0.5 | 0.5 | 0.5 |
| Total | 100 | 100 | 100 | 100 | 100 | 100 | 100 | 100 | 100 | 100 |
| Evaluation | | | | | | | | | | |
| Fluffiness | 3.6 | 3.7 | 3.8 | 4.0 | 4.0 | 3.9 | 3.6 | 3.3 | 2.6 | 2.0 |
| Meltableness in | 3.4 | 3.6 | 3.8 | 4.0 | 4.0 | 4.0 | 3.9 | 3.7 | 3.4 | 2.9 |
| mouth | | | | | | | | | | |

TABLE 14

| Confectionary mix | Production Examples | | | | | | | | | |
|---|---|---|---|---|---|---|---|---|---|---|
| (mass %) | 9-4 | 14-1 | 14-2 | 14-3 | 14-4 | 14-5 | 14-6 | 14-7 | 14-8 | 14-9 |
| Milled rice flour | 25 | 25 | 25 | 25 | 25 | 25 | 25 | 25 | 25 | 25 |
| Brown rice flour | 25 | 25 | 25 | 25 | 25 | 25 | 25 | 25 | 25 | 25 |
| Average particle | 58 | 58 | 58 | 58 | 58 | 58 | 58 | 58 | 58 | 58 |
| diameter (μm) | | | | | | | | | | |
| Alginic acid ester | | 0.1 | 0.3 | 0.5 | 2 | 5 | 10 | 15 | | |
| Cellulose ether | | | | | | | | | 0.5 | 2 |
| Processed starch 1 | 40 | 39.9 | 39.7 | 39.5 | 38 | 35 | 30 | 25 | 39.5 | 38 |
| Seasoning | 6.5 | 6.5 | 6.5 | 6.5 | 6.5 | 6.5 | 6.5 | 6.5 | 6.5 | 6.5 |
| Leavening agent | 3 | 3 | 3 | 3 | 3 | 3 | 3 | 3 | 3 | 3 |
| Guar gum | 0.5 | 0.5 | 0.5 | 0.5 | 0.5 | 0.5 | 0.5 | 0.5 | 0.5 | 0.5 |
| Total | 100 | 100 | 100 | 100 | 100 | 100 | 100 | 100 | 100 | 100 |
| Evaluation | | | | | | | | | | |
| Fluffiness | 4.0 | 4.2 | 4.3 | 4.4 | 4.4 | 4.3 | 4.3 | 4.2 | 4.3 | 4.4 |
| Meltableness in | 3.8 | 4.1 | 4.3 | 4.5 | 4.5 | 4.4 | 4.3 | 4.1 | 4.4 | 4.5 |
| mouth | | | | | | | | | | |

TABLE 15

| | Production Examples | | | | |
|---|---|---|---|---|---|
| Confectionary mix (mass %) | 15-1 | 10-3 | 15-2 | 15-3 | 15-4 |
| Milled rice flour | 25 | 25 | 25 | 25 | 25 |
| Brown rice flour | 25 | 25 | 25 | 25 | 25 |
| Average particle diameter (μm) | 24 | 58 | 80 | 100 | 150 |
| Processed starch 1 | 30 | 30 | 30 | 30 | 30 |
| Corn starch | 10 | 10 | 10 | 10 | 10 |
| Seasoning | 6.5 | 6.5 | 6.5 | 6.5 | 6.5 |
| Leavening agent | 3 | 3 | 3 | 3 | 3 |
| Guar gum | 0.5 | 0.5 | 0.5 | 0.5 | 0.5 |
| Total | 100 | 100 | 100 | 100 | 100 |
| Evaluation | | | | | |
| Fluffiness | 3.8 | 4.0 | 3.9 | 3.7 | 3.3 |
| Meltableness in mouth | 4.0 | 4.0 | 4.0 | 4.0 | 3.8 |

### Test Example 4: Okonomiyaki without Using Eggs

According to the same procedure as in Test Example 3, however, the liquid eggs to be added to the confectionary mix was replaced with water, and the okonomiyaki was produced and evaluated. The results are shown in Table 16 together with Production Examples 10-1, 9-1 and 10-5.

TABLE 16

| Confectionary mix | Production Examples | | | Production Examples | | |
|---|---|---|---|---|---|---|
| (mass %) | 10-1 | 9-1 | 10-5 | 16-1 | 16-2 | 16-3 |
| Milled rice flour | 10 | 15 | 30 | 10 | 15 | 30 |
| Brown rice flour | 10 | 15 | 30 | 10 | 15 | 30 |
| Average particle | 58 | 58 | 58 | 58 | 58 | 58 |
| diameter (μm) | | | | | | |
| Processed starch 1 | 30 | 30 | 30 | 30 | 30 | 30 |
| Corn starch | 40 | 30 | | 40 | 30 | |
| Seasoning | 6.5 | 6.5 | 6.5 | 6.5 | 6.5 | 6.5 |
| Leavening agent | 3 | 3 | 3 | 3 | 3 | 3 |
| Guar gum | 0.5 | 0.5 | 0.5 | 0.5 | 0.5 | 0.5 |
| Total | 100 | 100 | 100 | 100 | 100 | 100 |
| Presence or absence | Yes | | | No | | |
| of use of | | | | | | |
| liquid eggs | | | | | | |
| Evaluation | | | | | | |
| Fluffiness | 3.0 | 4.0 | 3.8 | 3.0 | 3.5 | 3.6 |
| Meltableness | 3.6 | 4.2 | 3.3 | 3.4 | 4.0 | 3.2 |
| in mouth | | | | | | |

1. A confectionary mix, comprising:
a rice flour in a range of from 20 to 60 mass %, the rice flour comprising 40 mass % or more of a brown rice flour; and
a processed starch in a range of from 10 to 50 mass %,
wherein the processed starch comprises a crosslinked starch, an etherified crosslinked starch, and/or an acetylated starch.

2. The confectionary mix of claim 1, wherein the rice flour comprises the brown rice flour in a range of from 100 to 40 mass % and a milled rice flour in a range of from 0 to 60 mass %.

3. The confectionary mix of claim 1, comprising:
the brown rice flour in 10 mass % or more.

4. The confectionary mix of claim 1, wherein the processed starch comprises a phosphate crosslinked starch, a hydroxypropylated crosslinked starch, and/or an acetic acid starch.

5. The confectionary mix of claim 1, further comprising:
an alginic acid and/or a cellulose ether, in a total mass in range of from 0.1 to 10 mass %.

6. The confectionary mix of claim 1, wherein the rice flour has an average particle diameter in a range of from 20 to 100 μm.

7. The confectionary mix of claim 1, wherein the confectionary is baked confectionary.

8. The confectionary mix of claim 1, which comprises no wheat flour or gluten.

9. A method for producing confectionary, the method comprising:
preparing a dough using the confectionary mix of claim 1.

10. The method of claim 9, wherein the dough comprises the confectionary mix in 100 parts by mass and a liquid in a range of from 30 to 300 parts by mass.

11. The method of claim 9, further comprising baking or deep-frying the dough.

12. The method of claim 9, wherein the dough comprises no wheat flour or gluten.

13-20. (canceled)

21. The confectionary mix of claim 1, wherein the processed starch is at least one selected from the group consisting of a crosslinked starch, an etherified crosslinked starch, and an acetylated starch.

22. The confectionary mix of claim 1, wherein the processed starch is at least one selected from the group consisting of a phosphate crosslinked starch, a hydroxypropylated crosslinked starch, and an acetic acid starch

23. The confectionary mix of claim 1, wherein the processed starch comprises the phosphate crosslinked starch.

24. The confectionary mix of claim 1, wherein the processed starch comprises the hydroxypropylated crosslinked starch.

25. The confectionary mix of claim 1, wherein the processed starch comprises the acetic acid starch.
